(19) United States
(12) Patent Application Publication
(10) Pub. No.: US 2008/0180775 A1
(43) Pub. Date: Jul. 31, 2008

(54) GALVANOMETRIC MOTOR WITH OPTICAL POSITION DETECTION DEVICE

(75) Inventor: Alistair Baillie Gill, Thaining (DE)

Correspondence Address: DUANE MORRIS LLP, 505 9th Street, Suite 1000, WASHINGTON, DC, 20004-2166, US

(73) Assignee: Raylase AG, Wessling (DE)

(21) Appl. No.: 12/016,090

(22) Filed: Jan. 17, 2008

(30) Foreign Application Priority Data
Jan. 25, 2007 (DE) 10 2007 003 852.8

(51) Int. Cl. G02B 26/08

(52) U.S. Cl. 359/223

(57) ABSTRACT

Disclosed is a Galvanometric motor with a rotor and a position detection device, which comprises the following: a deflection element, which is rigidly connected to the rotor and which has a reflection surface, first illumination means in order to direct a first light beam on to the reflection surface of the deflection element, and a first detection device for receiving the first light beam reflected by the reflection surface. The reflection surface of the deflection element is at an angle to the axis of rotation of the rotor, and the axis of rotation of the rotor extends through it. In addition the first light beam is directed on to the reflection surface in such a way that it forms an angle of less than 35°, preferably less than 10°, with the axis of rotation of the rotor.

### FIELD OF THE INVENTION

The present invention relates to galvanometric motors.

### BACKGROUND OF THE INVENTION

Galvanometric motors are also known by the terms “galvanometer scanners” or in brief “Galvo”, and are used for example in laser scanning systems, in which a laser beam is deflected by a deflecting mirror fixed to the rotor and in which by suitable rotation of the rotor, for example a workpiece to be processed can be scanned.

In order to control a laser scanning process of this kind, the rotational position or angular position of the rotor must be continuously detected. This rotational position of the rotor is then normally input into a control loop as an actual value, and the galvanometric motor is then driven in such a way that it moves the rotor into a current target position. The precision of the entire laser scanning system is therefore limited by the precision of the position detection device.

An important type of position detection devices are so-called capacitive position detection detectors. In these detectors the rotor is connected to an adjustable capacitor or to a dielectric, which is arranged between the plates of the capacitor. The measurement of the capacity of the capacitor supplies a quantity which is directly related to the angle of rotation of the rotor. The advantages of capacitive position detector consist in their high angular resolution and their high detection stability or reproducibility. “Reproducibility” in this context means that the relationship between measured capacity and actual angular position of the rotor is stable over fairly long periods of time and is not subject to so-called “drift”. However, the manufacture of such capacitive detectors is relatively cost intensive, and the capacitive detector increases the moment of inertia of the rotor, which is a disadvantage especially in small and/or particularly fast running galvanometric motors.

As an alternative, optical position detection devices are used in galvanometric motors. From U.S. Pat. No. 6,921,893 and WO 99/54688, galvanometric motors are known in which a butterfly-shaped diaphragm is fixed to one end of the rotor. Depending on the position of the rotor, the butterfly-shaped diaphragm blocks light falling on different segments of a photodetector. The position of the rotor can then be reconstructed out of the signals from the different segments of the photodetector. A position detection device of this kind however has the disadvantage that the diaphragm requires a relatively large amount of space and increases the moment of inertia of the rotor. This structure therefore makes compact construction and fast operation of the galvanometric motor more difficult.

From WO 01/06625, a galvanometric motor with an optical position detection device according to the preamble of Claim 1 is known. In this galvanometric motor, an additional mirror is arranged on the rear of a deflecting mirror connected to the rotor. The position detection system comprises a light source, which directs a light beam on to this additional mirror, and a position-sensitive detector which receives the light beam reflected by this additional mirror. From the point of incidence of the reflected light beam on the position-sensitive detector, the angular position of the rotor or of the deflecting mirror can then be reconstructed. A problem with this known system is however the fact that small radial movements of the rotor also lead to a displacement of the point of incidence of the reflected light beam on the position-sensitive detector, and are then misinterpreted as rotation of the rotor.

The problem that even small radial movements of the rotor falsify the angular measurement has been recognised in U.S. Pat. No. 5,671,043. In order to overcome this problem, a position detection system is proposed there, in which a diaphragm is also attached to one end of the rotor, but which in this case is aligned along the rotor axis. A pair of LEDs is arranged next to the diaphragm. Between the LEDs, four photocells are arranged. The diaphragm is dimensioned in such a way that the length thereof in the axial direction is larger than the axial direction of the active region of each of the photocells. The geometry of the diaphragm is also chosen such that the edges of the diaphragm cast shadows that cover approximately half of each photocells when the rotor is in a central position. When the diaphragm rotates in tandem with the rotor, the shadows move across the surfaces of the four photocells. From the output signals of the photocells, the angular position of the rotor can then be reconstructed. However this design is again rather complicated and requires a relatively large amount of space, which conflicts with a compact construction. Moreover, in this case also, the moment of inertia of the rotor is increased due to the diaphragm.

It is an object of the invention to disclose a galvanometric motor with a position detection device, which allows a high level of detection accuracy with a simple construction, and which allows operation at high rotational speed.

### SUMMARY OF THE INVENTION

In a galvanometric motor according to an embodiment of the invention, the position detection device comprises a deflection element, which is rigidly connected to the rotor and which has a reflection surface at an angle to the axis of rotation and through which deflection element the axis of rotation of the rotor extends. A first illumination means generates a first light beam, which is directed on to the reflection surface in such a way that it forms an angle of less than 35°, preferably less than 10°, with the axis of rotation of the rotor. The first light beam is then reflected by the reflection surface on to a detection device.

Roughly speaking, the galvanometric motor according to the invention is therefore characterised in that the first light beam is radiated essentially along the rotational axis of the rotor and that the deflection element, for example a simple mirror, is arranged essentially on the rotational axis of the rotor and at an angle to the same. The arrangement of the deflection element on the axis of rotation of the rotor only minimally increases the moment of inertia thereof. The radiation of the first light beam along the rotor axis minimises the influence that a radial movement of the rotor axis has on the position measurement, as will be described in more detail below with the aid of an exemplary embodiment. This particular technical effect of the invention is at its strongest if the first light beam is radiated exactly along the axis of rotation of the rotor. The effect is however still clearly present if the radiation angle deviates by as much as about 10° from the rotational axis of the rotor, and is still present for deviations of up to about 30°, to the extent that a perceptible improvement is found relative to the prior art.

In a preferred embodiment the rotor has a first end for holding an optical element, for example a deflection mirror for a laser scanning system, and the deflection element of the position detection device is arranged on a second end of the rotor, which is at the opposite end to the first end of the rotor. When the galvanometric motor is then used in a laser scanning system, the position detection system is maximally far away from the deflecting mirror of the laser scanner system and is thereby minimally influenced by the build up of heat that is generated when using high intensity laser light in laser scanning. Temperature induced errors in the position detection are thus kept small.

Preferably, the first detector device is formed by an optical position sensor that is suitable for detecting the position at which the first light beam reflected by the deflection element strikes an incident surface of the optical position sensor. The optical position sensor can be for example a known analogue sensor based on a lateral photo-effect. The advantage of such an analogue sensor is its simplicity and accuracy and in its high response speed.

The optical position sensor preferably has a front face, on which the incident surface for the first light beam is located, and it is arranged such that the incident surface is at an angle to the first light beam reflected by the deflection element. This prevents the possibility that a part of the received light beam is reflected by the incident surface back in the direction from which it originated, and thus that the sensor result is falsified or non-linearities are generated in the sensor behaviour due to multiple reflections.

In addition or alternatively the optical position sensor is arranged such that the rear side thereof is essentially open and exposed to the surrounding air. The light energy received by the optical position sensor is thereby uniformly and symmetrically dissipated as heat, which contributes to a stable sensor output and prevention of sensor drift.

In a particularly advantageous embodiment, the position detection device comprises second illumination means in order to direct a second light beam on to the reflection surface of the deflection element, a second detector device for receiving the second light beam reflected by the reflection surface, and a calibration device, which is suitable for calibrating the first detection de-vice depending on detection signals of the second detection device. Any drift, resulting for example from temperature effects on the first detection device, can thus be simply compensated for by calibration. The calibration can be performed for example in regularly conducted calibration steps.

The second detection device does not need to be suitable for a continuous detection of the position of the rotor, rather it is sufficient for it to be able to detect discrete states of the rotor. On the other hand it should be drift-free itself. In a preferred embodiment the second detection device comprises at least one, preferably two split photodiodes, which are arranged a distance apart for each other. With such a split photodiode a state, in which the centre of the second light beam is directed on to the boundary between the two halves of the photodiode can be detected almost independently of external influences. Since the split photodiode is stationary, the associated position of the rotor can therefore be reliably and reproducibly detected. Thus the split photodiode allows a stable calibration over arbitrarily long periods, and therefore the above mentioned reproducibility in the position detection.

Alternatively, other discrete optical sensors could also be used for the second detection device, for example a CCD- or CMOS-array.

Alternatively also, the first detection device can be formed as a whole by means of an array of discrete light-sensitive elements, in particular a CCD- or CMOS-array.

In an advantageous embodiment, the rotor comprises at least two radial magnet sectors with different polarity. The galvanometric motor further comprises a stator, which surrounds the rotor and consists of a plurality of stator plates, whereby each stator plate has at least twice as many inward pointing teeth as the rotor has magnet sectors. The additional teeth play no role in the active generation of a torque in the operation of the motor, but they create a suitable magnetic environment, which helps to keep the rotor in the neutral position, as will be explained in more detail below with the aid of an exemplary embodiment.

Preferably the galvanometric motor comprises a stop element, for example a stop pin, which is arranged on the second end of the rotor and limits the maximal rotation of the rotor. A biasing element, especially a coil spring, is further provided, which biases the rotor in the axial direction. Due to this axial biasing of the rotor, the bearings of the rotor are pretensioned, due to which a radial movement of the rotor is kept small and thereby the detection accuracy increased. The coil spring can be supported by the stop pin. A coil spring has the advantage in comparison to the normally used disc spring that it has a low spring constant, and the biasing force is almost constant in the working range of axial movements of the rotor. This leads to a more consistent and smooth motion of the rotor.

In a particularly advantageous embodiment, the rotor is arranged in the axial direction with respect to the stator in such a way that it either experiences no axial force, or an axial force acting in the same direction as the biasing force of the biasing element. In this case the axial biasing force is at least not weakened, possibly even supported by the magnetic interaction between the rotor and the stator, which in turn allows the use of a spring of relatively low spring constant.

### BRIEF DESCRIPTION OF THE DRAWINGS

The figures shown an exemplary embodiment of the invention, namely

FIG. 1 a perspective view of a galvanometric motor,

FIG. 2 a vertical longitudinal section of the galvanometric motor of FIG. 1,

FIG. 3 a horizontal longitudinal section of the galvanometric motor of FIG. 1,

FIG. 4 a schematic illustration of a position detection device,

FIG. 5 a view of a rotor and of a stator surrounding said rotor, viewed along the direction of the axis of rotation of the rotor,

FIG. 6 a perspective view of the stator without rotor,

FIG. 7 a sketch for illustrating the influence of radial movements of the rotor on the position detection in the invention, and

FIG. 8 a sketch for illustrating the influence of radial movements of the rotor on the position detection in the prior art.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

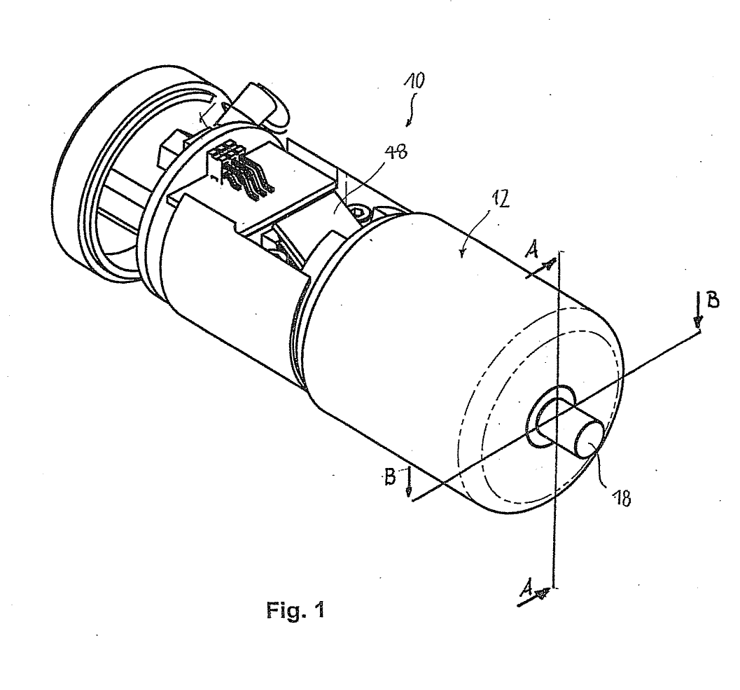

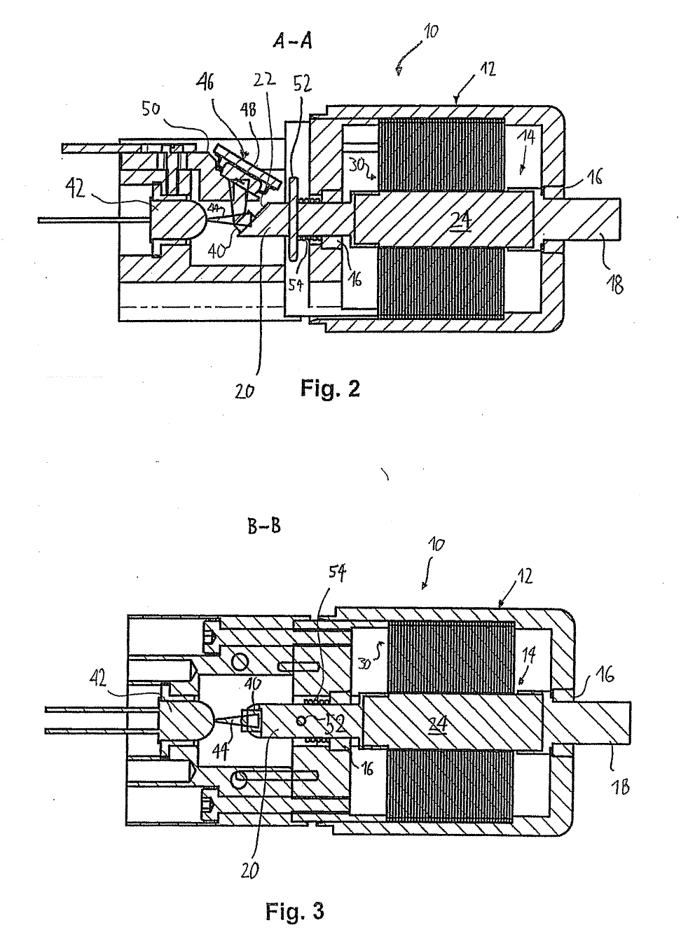

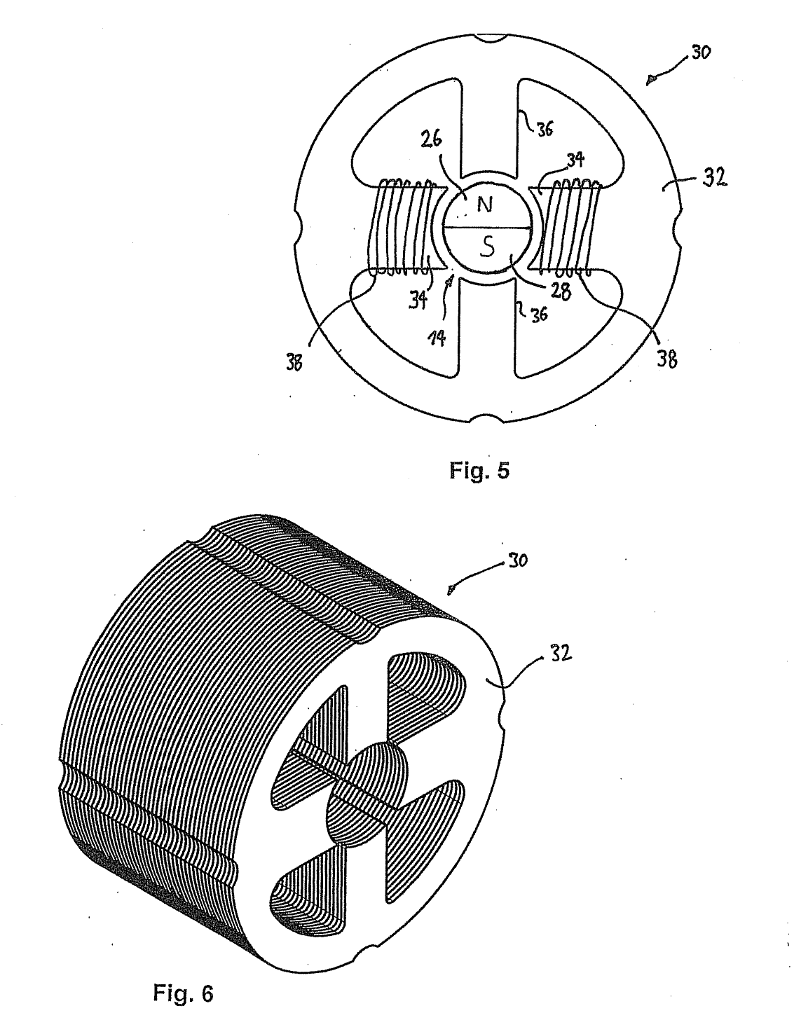

FIG. 1 shows a perspective view of a galvanometric motor 10 according to one embodiment of the invention. FIG. 2 shows a vertical longitudinal section A-A and FIG. 3 a horizontal longitudinal section B-B of the galvanometric motor 10 of FIG. 1. The galvanometric motor 10 of FIGS. 1 to 3 comprises a housing 12, in which a rotor 14 is rotatably mounted by means of bearings 16. The rotor 16 comprises a first end 18, which projects from the housing 12. To the first end 18, an optical element, for example a deflecting mirror of a laser scanner, is fixed. The rotor 14 further comprises a second end 20 with an end surface 22, positioned at an angle of 45° to the longitudinal axis of the rotor 14. Between the first and the second end 18, 20 a magnet section 24 is arranged, one longitudinal half of which forming a magnetic north pole 26 (see FIG. 5) and the other longitudinal half of which forming a magnetic south pole 28.

The magnet section 24 of the rotor 14 is arranged in a stator 30, which is shown in a perspective view in FIG. 6. The stator 30 consists of a plurality of stator plates 32 layered on top of each other. In FIG. 5 a view of the stator 30 along the axis of rotation of the rotor 14 is shown, in which the shape of the front-most stator plate 32 in this view can be seen particularly well. As can be seen in FIGS. 2, 3 and 5, the stator 30 surrounds the magnet section 24 of the rotor 14. The individual stator plates 32 have a first pair of teeth 34 and a second pair of teeth 36, wherein all the teeth 34, 36 extend radially inwards in the direction towards the rotor 14. The first pairs 34 of teeth of the plates 32 of the stator 30 are jointly surrounded by one coil 38 each, which in FIG. 5 is only indicated schematically.

As can be seen in FIGS. 2 and 3, on the slanted end surface 22 of the second end 20 of the rotor 14, a mirror 40 is arranged, the reflection surface of which is also positioned at an angle of 45° to the longitudinal axis of the rotor 14. The galvanometric motor 10 further comprises a first LED 42, which directs a first light beam 44 along the axis of rotation of the rotor 14 on to the mirror 40. The first light beam 44 is reflected by the mirror 40 and deflected on to an analogue optical position sensor 46.

The optical position sensor 46 in this embodiment is an analogue sensor with a flat semiconductor, a so-called pin-diode, which is illuminated in the form of points by the reflected first light beam 44. Due to the illumination, the local resistance, and thereby the currents flowing through electrodes (not shown) that are arranged on the transversal edges of the sensor, change. From the currents that flow through the electrodes, the location of the illumination can then be calculated in a known manner. An analogue sensor of this type is known by the term PSD.

The optical position sensor 46 has a front side, on which the incident surface of the first light beam 44 is located, and a rear side 48, which, as can be seen in FIGS. 1 and 2, is open and only surrounded by the ambient air. The entire optical position sensor 46 is only supported at its edges by supporting elements 50 and is otherwise freely suspended in the air.

In the region of the second end 20 of the rotor 14 there is a stop pin 52, which restricts the rotation of the rotor 14 to a pre-defined maximal angular range. Between the stop pin 52 and the bearing 16 opposite to it, a coil spring 54 is arranged, which pre-tensions or biases the rotor 14 in the axial direction.

In the following, the function of the galvanometric motor 10 and the particular technical effects of the features thereof are explained.

By the application of a suitable current to the coils 38 (see FIG. 5), a magnetic field is generated that exerts a torque on the magnet section 24 of the rotor 14. During operation of the galvanometric motor 10 the current position, i.e. angular position of the rotor 14, is constantly detected and this position is input as an actual value into a controller (not shown). The controller compares this actual value with a current target value and drives the coils 38 in such a way that they generate a suitable magnetic field, in order to make the position of the rotor 14 approach the current target value.

The detection of the current position of the rotor 14 takes place via the optical position sensor 46. As can be seen from FIG. 2, the point of incidence of the first light beam 44 on the optical position sensor 46 during the rotation of the rotor 14 travels along a direction vertical to the plane of the drawing of FIG. 2. The movement of the point of incidence of the first light beam 44 is detected by the optical position sensor 46, and it generates a signal from which the angular position of the rotor 14 can be reconstructed.

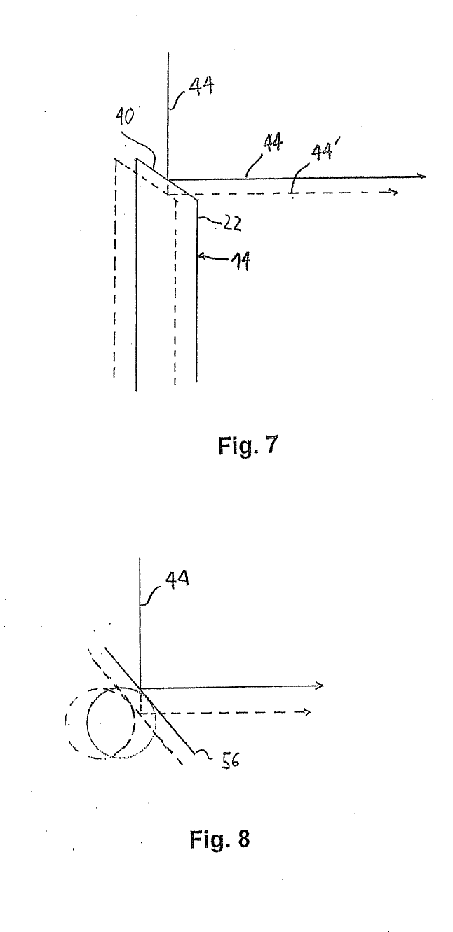

A special feature of the galvanometric motor 10 of FIG. 2 is the fact that the first light beam 44 is directed by the LED 42 on to the mirror 40 along the longitudinal axis or axis of rotation of the rotor 14. This arrangement makes the position detection stable with respect to a radial displacement of the rotor 14, as is to be explained with the aid of the simple sketch of FIG. 7.

FIG. 7 shows in solid lines the second end 22 of the rotor 14 in its normal position, and in dashed lines the second end 22 in a position radially displaced relative to the normal position. As can be seen in FIG. 7, the reflected light beam 44 (solid line) and the reflected light beam 44′ (dashed line) as resulting according to the normal or displaced position of the rotor 14, respectively, are displaced relative to each other. This displacement however lies in a plane that is parallel to the longitudinal axis of the rotor 14. The point of incidence of the light beam 44 or 44′ on the optical position sensor 46 therefore travels, as a consequence of the offset between the reflected light beams 44 and 44′, in a direction that is perpendicular to the movement of the point of light due to a rotation of the rotor 14. Thus, the position measurement of the rotor 14 is not falsified due to this offset.

A different behaviour however occurs if, deviating from the construction of the invention, a mirror 56 were arranged tangentially to the rotor and if the light beam 44 were to strike the mirror 56 in a plane perpendicular to the longitudinal axis of the rotor 14. As is immediately clear from FIG. 8, in such a case a radial displacement of the rotor 14 leads to an offset of the reflected light beam 44′ relative to the normal reflected light beam 44, which the optical position sensor 46 cannot distinguish from a displacement of the point of incidence due to a rotation of the rotor 14. In such an arrangement therefore, even small radial displacements of the rotor 14 lead to an erroneous detection of the position of the rotor 14, which is not tolerable for high quality applications.

In FIG. 8 the extreme case was discussed, in which the incident light beam 44 lies in a plane perpendicular to the axis of rotation of the rotor 14. It should be borne in mind however, that the effect described in connection with FIG. 8 also occurs when the vector of the propagation direction of the incident light beam 44 has only one component in the plane perpendicular to the axis of rotation of the rotor 14. Precisely this component is prevented however, if according to the invention the incident light beam 44 is radiated along, or at least almost along, the axis of rotation of the rotor 14 on to the mirror 40.

As was mentioned above and can be seen in FIG. 2, the incident surface of the optical position sensor 46 is inclined relative to the direction of incidence of the reflected first light beam 44. This prevents the light beam 44 received by the optical position sensor 46 from being reflected via the mirror 40 on the same path back to the LED 42 and from this back again to the position sensor 46. The inventors have found out that by means of this relatively simple measure, a large portion of the non-linearities in the position detection can be prevented.

Due to the fact that the optical position sensor 46, as described above, is “suspended” in the air, it can dissipate the light energy that it receives from the first light beam 44 uniformly and symmetrically. This allows a drift in the measurement results of the position sensor 46 caused by a temperature gradient within the sensor to be minimised. In this respect it is furthermore advantageous, if all possible components for the position detection, in particular the position detector 46, are arranged in the region of the second end 20 of the rotor 14. As was mentioned earlier, a particularly important application area of the galvanometric motor 10 is a laser scanning system, in which a deflecting mirror (not shown) would be fixed to the first end 18 of the rotor 14. Due to the light energy of the deflected laser beam, the region of the first end 18 is heated, which in turn can lead to a drift in the position detection. In the embodiment shown, the entire position detection device by contrast is arranged at the second end 20 of the rotor 14 and thus maximally distant from the first end 18.

As can particularly be seen from FIGS. 2 and 3, the rotor 14 essentially consists of three sections, namely the first end 18, the second end 20 and the magnet section 24 lying inbetween. When the rotor 14 is assembled, the second section with the slanted surface 40 must be exactly aligned with the magnet section 24. The stop pin 52 is also arranged in this second section 20 (see FIGS. 2 and 3). If the stop pin 52 were arranged by contrast on the first end 18 of the rotor 14, as is common in many galvanometric motors from the prior art, then this first section 18 would also have to be precisely aligned with the magnet section 24 during assembly of the rotor 14. This requirement is removed in the galvanometric motor 10 in the embodiment shown here, which simplifies the assembly.

In the following, the special technical effect of the shape of the stator plates 32 of the stator 30 is described with reference to FIG. 5. Galvanometric motors with a movable magnetic rotor typically do not have a stator. Instead, the coils are usually filled with air only. In known galvanometric motors with a movable magnetic rotor and stator, the associated stator however has just as many inward pointing teeth as the rotor has magnet segments. That means that in a rotor with two magnet segments as in the embodiment shown, the stator 30 would have only the teeth 38, but not the additional teeth 36. FIG. 5 shows the rotor 14 in its neutral or normal position, from which it can be rotated clockwise and counter-clockwise by the same angular amount. Without the additional teeth 36, a so-called “spring effect” or “flipover effect” occurs. This “flipover effect” manifests itself in the rotor 14 being in an unstable equilibrium when the coil current is switched off in the normal position shown in FIG. 5. As soon as the rotor 14 is rotated by a small amount from the normal position shown in FIG. 5, due to the magnetic force of the permanent magnets 26, 28 interacting with the teeth 34—if one imagines the additional teeth 36 to be absent—it experiences a torque which accelerates it further out of the neutral position, so that it jumps out of the neutral position into one of the extreme position defined by the stop pin 52. This flip-over effect hampers a rapid reversal of motion in the active operation of the galvanometric motor, and is therefore in conflict with a high operating speed.

The flipover effect described is balanced out in the embodiment of FIGS. 5 and 6 by the additional teeth 36. The additional teeth 36 play no part in supplementing the active torque, but they are constructed in such a way that they at least partially prevent the flipover effect described above and the parasitic torque resulting therefrom.

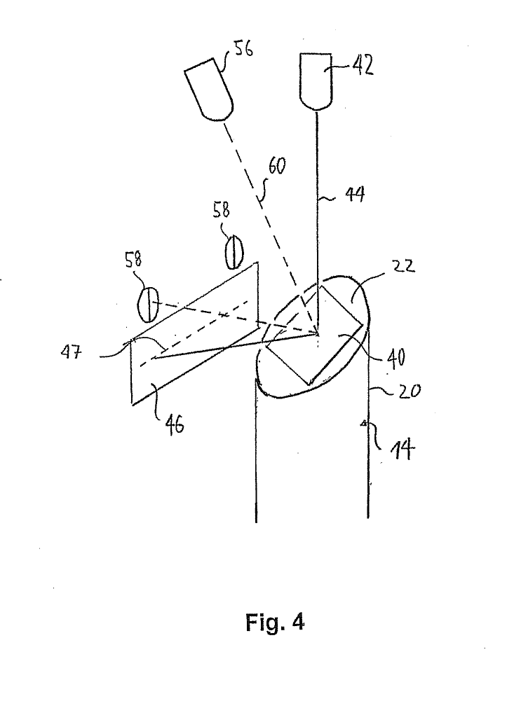

In FIG. 4 a further embodiment of a position detection device is illustrated schematically. FIG. 4 shows in perspective view the first end 20 of the rotor 14 with the slanted surface 22 and the mirror 40. In addition, FIG. 4 shows as a first illumination means the LED 42, which emits a light beam 44 that is reflected by the mirror 40 on to the position sensor 46. The line or row, on or in which the reflected light beam 44 strikes the incident surface of the position sensor 46 in different rotational positions of the rotor 14, is shown dashed in FIG. 4 and labelled with reference number 47.

In this embodiment, a second illumination means is provided in the form of a further LED 56, which emits a second light beam 60, which in the position of the rotor 14 shown in FIG. 4 is reflected on to one of two split photodiodes 58 arranged at a distance apart from each other. Each of the photodiodes 58 can be used to detect a corresponding position of the rotor 14, namely the position in which the centre of the reflected light beam 60 strikes the boundary line of the split photodiode 58. As the photodiodes 58 in the embodiment described here are fixed to the housing (not shown in FIG. 4) of the galvanometric motor, two absolute angular positions of the rotor can be detected in a drift-free manner. By using these angular positions, the analogue optical position sensor 46 can be calibrated as required. This allows in particular the above mentioned drift of the optical sensor 46 during operation to be compensated in intermediate test stages by calibration.

The previously described features can be of significance in any arbitrary combination.

### LIST OF REFERENCE LABELS

10 galvanometric motor
12 housing
14 rotor
16 bearing
18 first end of the rotor 14
20 second end of the rotor 14
22 slanted surface
24 magnet section
26 north sector of the magnet section 24
28 south sector of the magnet section 24
30 stator
32 stator plate
34 first stator plate tooth
36 second stator plate tooth
38 coil
40 mirror
42 LED
44 first light beam
46 optical position sensor
47 row of points of light
48 rear side of the optical position sensor 46
50 suspension mounting of the optical position sensor 46
52 stop pin
54 coil spring
56 LED
58 split photodiode
60 second light beam

1. A galvanometric motor having a rotor and a position detection device, comprising:
a deflection element, rigidly connected to the rotor and having a reflection surface;
a first illumination means, to direct a first light beam on to the reflection surface of the deflection elements and;
a first detection device for receiving the first light beam reflected by the reflection surface,
wherein the reflection surface is at an angle to the axis of rotation of the rotor and the axis of rotation of the rotor extends through the reflection surface, and;
wherein the first light beam is directed on to the reflection surface in such a way that it forms an angle of less than 35°, preferably less than 10°, with the axis of rotation of the rotor.

2. The galvanometric motor according to claim 1, wherein the deflection element is formed by a mirror.

3. The galvanometric motor according to claim 1, wherein the rotor has a first end for holding an optical element, and wherein the deflection element is arranged on a second end of the rotor opposite to the first end of the rotor.

4. The galvanometric motor according to claim 1, wherein the angle between the reflection surface of the deflection element and the axis of rotation of the rotor has a value of between 30° and 60°, preferably between 40° and 50°.

5. The galvanometric motor according to claim 1, wherein the first detection device is formed by an optical position sensor, which is suitable for detecting the position at which the first light beam reflected by the deflection element strikes an incident surface of the optical position sensor.

6. The galvanometric motor according to claim 5, wherein the optical position sensor is an analogue sensor.

7. The galvanometric motor according to claim 5, wherein the optical position sensor has a front face on which the incident surface for the first light beam is located, and a rear side, wherein the optical position sensor is arranged such that the incident surface is at an angle to the first light beam reflected by the deflection element, and/or is arranged such that the rear side is essentially open and exposed to the surrounding air.

8. The galvanometric motor according to claim 1, further comprising second illumination means for directing a second light beam on to the reflection surface, a second detection device for receiving the second light beam reflected by the reflection surface, and a calibration device suitable for calibrating the first detection device according to detection signals of the second detection device.

9. The galvanometric motor according to claim 8, wherein the second detection device comprises at least one split photodiode, preferably two split photodiodes, which are arranged at a distance apart from each other.

10. The galvanometric motor according to claim 8, wherein the second detection device comprises at least one discrete optical sensor, in particular a CCD- or CMOS-array.

11. The galvanometric motor according to claim 1, wherein the first detection device is formed by an array of discrete light-sensitive elements, in particular a CCD- or CMOS-array.

12. The galvanometric motor according to claim 1, wherein the rotor has at least two radial magnetic sectors with different magnetic polarity.

13. The galvanometric motor according to claim 1, said motor having a stator, surrounding the rotor and consisting of a plurality of stator plates, wherein each stator plate has at least twice as many inward pointing teeth as the rotor has magnet sectors.

14. The galvanometric motor according to claim 13, wherein every second one of the teeth is surrounded by a coil.

15. The galvanometric motor according to claim 1, further comprising a stop element, in particular a stop pin, which is arranged on the second end of the rotor and limits the maximal rotation of the rotor.

16. The galvanometric motor according to claim 1, further comprising a biasing element, especially a coil spring, biasing the rotor in the axial direction.

17. The galvanometric motor according to claim 15 claim 16, wherein a coil spring is supported by said stop pin.

18. The galvanometric motor according to claim 16, wherein the rotor is axially arranged with respect to the stator in such a way that it either experiences no axial force, or an axial force acting in the same direction as the biasing force of the biasing element.

19. The galvanometric motor according to claim 16, wherein said coil spring is supported by said stop pin.
